(19) United States
(12) Patent Application Publication
(10) Pub. No.: US 2025/0034326 A1
(43) Pub. Date: Jan. 30, 2025

(54) ALIPHATIC-AROMATIC POLYESTERS WITH A CONTROLLED CONTENT OF MIXED RESIDUAL CYCLIC OLIGOMERS

(71) Applicant: Novamont S.p.A., Novara (IT)

(72) Inventors: Catia BASTIOLI, Novara (IT); Sebastià GESTI GARCIA, Torino (IT); Roberto VALLERO, Borgo D Ale (VC) (IT)

(73) Assignee: Novamont S.p.A., Novara (IT)

(21) Appl. No.: 18/716,543

(22) PCT Filed: Dec. 6, 2022
(86) PCT No.: PCT/EP2022/084498

§ 371 Date: Jun. 5, 2024

(30) Foreign Application Priority Data
Dec. 6, 2021 (IT) 102021000030725

(51) Int. Cl. C08G 63/183; C08G 63/85; C08G 63/87

(52) U.S. Cl. CPC C08G 63/183; C08G 63/85; C08G 63/87

(57) ABSTRACT

Aliphatic-aromatic polyesters with a controlled amount of mixed residual cyclic oligomers having certain ratios between cyclic oligomers containing at least two types of dicarboxylic aliphatic units having a molecular mass below 1000 and cyclic oligomers containing only one type of dicarboxylic aliphatic unit having a molecular mass below 1000, and process for their preparation.

The present invention relates to aliphatic-aromatic polyesters having suitable thermal stability and terminal acidity properties with a controlled content of mixed residual cyclic oligomers as by-products of the polymerisation process, and a process for obtaining them. These aliphatic-aromatic polyesters are such that more stable film processing and thus higher productivity can be achieved.

It is known that a content of mixed residual cyclic oligomers in aliphatic-aromatic polyesters is undesirable because such a content has an adverse influence on polyester properties, in particular the mechanical performance and transparency properties of the films obtained from them.

Patent application WO2016/050963 describes a combined process for the production of polyesters comprising an esterification or transesterification step and a subsequent polycondensation step, characterised in that said polycondensation step is carried out in the presence of a catalyst comprising a mixture of at least one Titanium compound and at least one Zirconium compound in which the Ti/(Ti+Zr) ratio by weight is not greater than 0.01 and not less than 0.70.

WO2016/050963 teaches that through this process it is possible to obtain polyesters with a reduced formation of mixed cyclic residues that are removed by distillation during the polycondensation step.

Nevertheless, some of these mixed residual cyclic oligomers remain trapped within the forming polyester.

It has been found that by appropriately selecting the conditions of the process described in WO2016/050963, in particular through the addition of phosphorus-containing compounds in appropriate amounts relative to the catalyst used, together with specific temperature and pressure conditions, it is possible to obtain aliphatic-aromatic polyesters with a controlled amount of mixed residual cyclic oligomers characterised by a ratio of between 0.30 and 1.40, more preferably between 0.40 and 1.20, even more preferably between 0.45 and 0.80 between cyclic oligomers containing at least two types of aliphatic dicarboxylic units and having a molecular mass (MM) below 1000 and cyclic oligomers containing only one type of aliphatic dicarboxylic unit with an MM below 1000, and further characterised in that the predominant saturated aliphatic dicarboxylic acid in the mixture of dicarboxylic acids is less than 95% in moles with respect to the sum of all the other saturated aliphatic dicarboxylic acids, and more than 45% in moles with respect to the sum of all the saturated aliphatic dicarboxylic acids when more than two saturated aliphatic dicarboxylic acids are present.

Surprisingly, the polyesters obtained through this improved process allow for more stable film production conditions, in particular better bubble stability, which makes it possible to carry out the filming process at a higher flow rate.

By “mixed residual cyclic oligomers” in the present invention is meant those residual cyclic oligomers that remain in the polymer mass after the polycondensation process and have a molecular mass (MM) of below 1000.

One aspect of the present invention is therefore a process for the production of aliphatic-aromatic polyesters comprising the steps of:
1. subjecting a mixture comprising an aliphatic diol, at least one aromatic dicarboxylic acid and at least two aliphatic dicarboxylic acids, their esters, salts or derivatives to esterification and/or trans-esterification to produce an oligomer;
2. polycondensing said oligomer obtained from step 1 at a temperature between 220° C. and 260° C. and a pressure between 0.5 mbar and 350 mbar in the presence of a catalyst comprising titanium, possibly with zirconium or mixtures thereof, and a phosphorus-containing compound belonging to the family of organic phosphates or phosphites.

The term “derivative” of a dicarboxylic acid refers to a compound in which the hydroxyl of the acid is replaced by a group containing a halogen, nitrogen or sulfur atom bonded to the carbon of the carbonyl group.

Advantageously, the compound containing phosphorus is selected from compounds of general formula (1) or (2)

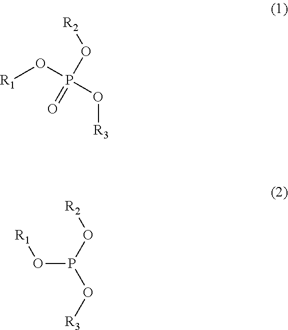

where R1, R2 and R3 may be selected from any of H, C1-C20 alkyl or cycloalkyl, C6-C20 aryl, alkyl aryl, or a polyalkylene oxide or polyalkylalkylene oxide chain.

In a preferred aspect of the process according to the invention, the catalyst comprises a mixture of at least one titanium compound and the ratio of titanium to phosphorus is between 2 and 20, preferably between 3 and 15.

Further aspects of the present invention comprise aliphatic-aromatic polyesters comprising:
(a) a dicarboxylic component comprising:
   (a1) 40-80% in moles of units derived from at least one aromatic dicarboxylic acid,
   (a2) 20-60% in moles of units derived from at least two saturated aliphatic C4-C24 dicarboxylic acids;
(b) an aliphatic diol component;
characterised in that the content of mixed residual cyclic oligomers is between 1.0% and 4.0%, in which said mixed residual cyclic oligomers are characterised in that the ratio between cyclic oligomers containing at least two types of aliphatic dicarboxylic units having an MM below 1000 and cyclic oligomers containing only one type of aliphatic dicarboxylic unit having an MM below 1000 is between 0.30 and 1.40, more preferably between 0.40 and 1.20, even more preferably between 0.45 and 0.80, and further characterised in that the predominant saturated aliphatic dicarboxylic acid in component a2 is between 45% in moles and 95% in moles compared to the sum of all the other saturated aliphatic dicarboxylic acids when component a2) is composed of more than two saturated aliphatic dicarboxylic acids.

The term “predominant saturated aliphatic dicarboxylic acid” in the present invention means that the term is applied when the ratio of the acids is not equimolecular, and thus the term designates the saturated aliphatic dicarboxylic acid present in a greater molar percentage than the percentage of each of the other saturated aliphatic dicarboxylic acids.

In a preferred aspect of the invention, the content of mixed residual cyclic oligomers is between 2% and 3.5%.

As regards the aliphatic-aromatic polyesters produced by the process according to the present invention, these comprise a diol component (component b) derived from at least one aliphatic diol selected from 1,2-ethanediol, 1,2-propanediol, 1,3-propanediol, 1,4-butanediol, 1,5-pentanediol, 1,6-hexanediol, 1,7-heptanediol, 1,8-octanediol, 1,9-noenediol, 1,10-decanediol, 1,11-undecanediol, 1,12-dodecanediol, 1,13-tridecanediol, 1,4-cyclohexanedimethanol, neopentylglycol, 2-methyl-1,3-propanediol dianhydrosorbitol, dianhydromannitol, dianhydroiditol, glycols with a molecular weight of 100-4000, such as polyethylene glycol, polypropylene glycol and mixtures thereof.

Preferably the diol component comprises at least 50 percent by moles of one or more diols selected from 1,2-ethanediol, 1,3-propanediol, 1,4-butanediol.

More preferably, the diol component comprises, or consists of, 1,2-ethanediol, 1,4-butanediol or mixtures thereof.

Even more preferably, the diol component comprises or consists of 1,4-butanediol.

The dicarboxylic component of the polyesters produced by the process according to the present invention comprises 40-80% in moles, preferably 40-75%, more preferably 42-60% in moles, even more preferably between 45 and 49.5% in moles with respect to the total dicarboxylic component, of units derived from at least one aromatic dicarboxylic acid (component a1) and 20-60% in moles, preferably 25-60% in moles, more preferably 40-58% in moles, more preferably between 50.5-55% in moles with respect to the total dicarboxylic component, of units derived from at least two saturated aliphatic dicarboxylic acids (component a2). The dicarboxylic component is further characterised in that the predominant saturated aliphatic dicarboxylic acid in component a2) is less than 95% in moles with respect to the sum of all the other saturated aliphatic dicarboxylic acids, and more than 45% in moles with respect to the sum of all the saturated aliphatic dicarboxylic acids when component a2) is composed of more than two saturated aliphatic dicarboxylic acids.

The aromatic dicarboxylic acids are advantageously selected from terephthalic acid, isophthalic acid, 2,5-furandicarboxylic acid, their esters, salts and mixtures.

In a preferred embodiment, the aromatic dicarboxylic acids comprise:
1 to 99% in moles, preferably 5 to 95% and more preferably 10 to 80%, of terephthalic acid, its esters or salts;
99 to 1% in moles, preferably 95 to 5% and more preferably 90 to 20%, of 2,5-furandicarboxylic acid, its esters or salts.

In a particularly preferred form of the present invention, the aromatic dicarboxylic acid is terephthalic acid, its esters and salts.

The aliphatic dicarboxylic acids are advantageously selected from saturated C4-C24, preferably C5-C24, more preferably C5-C13, more preferably C5-C11 dicarboxylic acids, their C1-C2, more preferably C1-C4, alkyl esters, their salts and mixtures thereof.

In a preferred embodiment of this invention, the aliphatic dicarboxylic acids are selected from: glutaric acid, 2-methylglutaric acid, adipic acid, succinic acid, pimelic acid, suberic acid, azelaic acid, sebacic acid, undecandioic acid, dodecandioic acid, brassylic acid and their C1-24 alkyl esters.

In a preferred embodiment of this invention, the predominant saturated aliphatic dicarboxylic acid is at least 45% in moles, preferably more than 60% in moles, more preferably more than 65% in moles, even more preferably more than 85% in moles than the sum of all the saturated aliphatic dicarboxylic acids when component a2) comprises more than two saturated aliphatic dicarboxylic acids. Such predominant saturated aliphatic dicarboxylic acid is preferably selected from adipic acid, azelaic acid, sebacic acid, brassylic acid, their C1-C24, preferably C1-C4, esters, salts and mixtures thereof.

In a particularly preferred embodiment of the present invention, one of the aliphatic dicarboxylic acids is azelaic acid.

In a preferred embodiment of the process according to the present invention, the aliphatic-aromatic polyester produced is advantageously selected from:
(A) polyesters comprising repetitive units derived from phthalic type aromatic dicarboxylic acids, preferably terephthalic acid, aromatic dicarboxylic acids and aliphatic diols (AAPE-A), characterised by an aromatic unit content of between 42-60% in moles, preferably between 45 and 49.5% in moles in relation to the total moles of the dicarboxylic component.

The AAPE-A polyesters are preferably selected from: poly(1,4-butylene adipate-co-1,4-butylene succinate-co-1,4-butylene terephthalate), poly(1,4-butylene brassylate-co-1,4-butylene succinate-co-1,4-butylene terephthalate), poly(1,4-butylene sebacate-co-1,4-butylene succinate-co-1,4-butylene terephthalate), poly(1,4-butylene adipate-co-1,4-butylene sebacate-co-1,4-butylene terephthalate), poly(1,4-butylene azelate-co-1,4-butylene sebacate-co-1,4-butylene terephthalate), poly(1,4-butylene brassylate-co-1,4-butylene sebacate-co-1,4-butylene terephthalate), poly(1,4-butylene adipate-co-1,4-butylene azelate-co-1,4-butylene terephthalate), poly(1,4-butylene adipate-co-1,4-butylene brassylate-co-1,4-butylene terephthalate), poly(1,4-butylene brassylate-co-1,4-butylene azelate-co-1,4-butylene terephthalate), poly(1,4-butylene azelate-co-1,4-butylene succinate-co-1,4-butylene terephthalate), poly(1,4-butylene adipate-co-1,4-butylene azelate-co-1,4-butylene sebacate-co-1,4-butylene terephthalate), poly(1,4-butylene azelate-co-1,4-butylene sebacate-co-1,4-butylene brassylate-co-1,4-butylene terephthalate), poly(1,4-butylene adipate-co-1,4-butylene azelate-co-1,4-butylene brassylate-co-1,4-butylene terephthalate), poly(1,4-butylene adipate-co-1,4-butylene sebacate-co-1,4-butylene brassylate-co-1,4-butylene terephthalate).
(B) polyesters comprising repeating units derived from aromatic heterocyclic dicarboxylic compounds, preferably 2,5-furandicarboxylic acid, aromatic dicarboxylic acids and aliphatic diols (AAPE-B), characterised by a content of aromatic units between 40 and 80% in moles, preferably between 40 and 75% in moles, with respect to the total moles of the dicarboxylic component.

The AAPE-B polyesters are preferably selected from: poly(1,4-butylene adipate-co-1,4-butylene succinate-co-2,5-furandicarboxylate), poly(1,4-butylene sebacate-co-1,4-butylene succinate-co-2,5-furandicarboxylate), poly(1,4-butylene brassylate-co-1,4-butylene succinate-co-2,5-furandicarboxylate), poly(1,4-butylene adipate-co-1,4-butylene sebacate-co-2,5-furandicarboxylate), poly(1,4-butylene azelate-co-1,4-butylene sebacate-co-2,5-furandicarboxylate), poly(1,4-butylene brassylate-co-1,4-butylene sebacate-co-2,5-furandicarboxylate), poly(1,4-butylene adipate-co-1,4-butylene azelate-co-2,5-furandicarboxylate), poly(1,4-butylene adipate-co-1,4-butylene brassylate-co-2,5-furandicarboxylate), poly(1,4-butylene brassylate-co-1,4-butylene azelate-co-2,5-furandicarboxylate), poly(1,4-butylene azelate-co-1,4-butylene succinate-co-2,5-furandicarboxylate), poly(1,4-butylene adipate-co-1,4-butylene azelate-co-1,4-butylene sebacate-co-2,5-furandicarboxylate), poly(1,4-butylene azelate-co-1,4-butylene sebacate-co-1,4-butylene brassylate-co-2,5-furandicarboxylate), poly(1,4-butylene adipate-co-1,4-butylene azelate-co-1,4-butylene brassylate-co-2,5-furandicarboxylate), poly(1,4-butylene adipate-co-1,4-butylene sebacate-co-1,4-butylene brassylate-co-2,5-furandicarboxylate).

The polyesters produced by the process according to the present invention are characterised by a content of mixed residual cyclic oligomers of between 1.0% and 4.0%, in which said oligomers are characterised by a ratio of between 0.30 and 1.40, more preferably between 0.40 and 1.20, even more preferably between 0.45 and 0.80 between cyclic oligomers containing at least two types of aliphatic dicarboxylic units having an MM below 1000 and cyclic oligomers containing only one type of aliphatic dicarboxylic unit having an MM below 1000, and further characterised in that the predominant saturated aliphatic dicarboxylic acid in component a2) is less than 95% in moles with respect to the sum of all the other saturated aliphatic dicarboxylic acids and more than 45% in moles with respect to the sum of all the other saturated aliphatic dicarboxylic acids when component a2) is composed of more than two saturated aliphatic dicarboxylic acids.

In a preferred aspect of the present invention the cyclic oligomers containing only one type of aliphatic dicarboxylic unit are (ADA-BDO)2, (AZA-BDO)2, (SEBA-BDO)2, (BRA-BDO)2, (ADA-BDO)3, (AZA-BDO)3, (SEBA-BDO)3, (BRA-BDO)3, (ADA-BDO)4, (AZA-BDO)4. In a preferred aspect of the present invention, the cyclic oligomers containing at least two types of aliphatic dicarboxylic units are (ADA-BDO-SUC-BDO), (SEBA-BDO-SUC-BDO), (BRA-BDO-SUC-BDO), (ADA-BDO-AZA-BDO), (ADA-BDO-SEBA-BDO), (ADA-BDO-BRA-BDO), (AZA-BDO-SEBA-BDO), (AZA-BDO-BRA-BDO), (SEBA-BDO-BRA-BDO), (SUC-BDO)2-(SEBA-BDO), (SUC-BDO)-(SEBA-BDO)2, (SUC-BDO)-(ADA-BDO)2, (SUC-BDO)2-(ADA-BDO), (SUC-BDO)-(BRA-BDO)2, (SUC-BDO)2-(BRA-BDO)(ADA-BDO)2-(AZA-BDO), (ADA-BDO)-(AZA-BDO)2, (ADA-BDO)2-(SEBA-BDO), (ADA-BDO)-(SEBA-BDO)2, (ADA-BDO)2-(BRA-BDO), (ADA-BDO)-(BRA-BDO)2, (AZA-BDO)2-(SEBA-BDO), (AZA-BDO)-(SEBA-BDO)2, (AZA-BDO)2-(BRA-BDO), (AZA-BDO)-(BRA-BDO)2, (SEBA-BDO)2-(BRA-BDO), (SEBA-BDO)-(BRA-BDO)2, (SUC-BDO)-(PTA-BDO)-(SEBA-BDO), (SUC-BDO)-(PTA-BDO)-(BRA-BDO), (SUC-BDO)-(PTA-BDO)-(ADA-BDO), (ADA-BDO)-(PTA-BDO)-(AZ-BDO), (ADA-BDO)-(PTA-BDO)-(SEBA-BDO), (ADA-BDO)-(PTA-BDO)-(BRA-BDO), (SEBA-BDO)-(PTA-BDO)-(AZ-BDO), (BRA-BDO)-(PTA-BDO)-(AZ-BDO), (BRA-BDO)-(PTA-BDO)-(SEBA-BDO), (ADA-BDO)-(AZA-BDO)-(SEBA-BDO), (ADA-BDO)-(AZA-BDO)-(BRA-BDO), (ADA-BDO)-(BRA-BDO)-(SEBA-BDO), (BRA-BDO)-(AZA-BDO)-(SEBA-BDO), (SUC-BDO)2-(ADA-BDO)2, (SUC-BDO)2-(BRA-BDO)2, (SUC-BDO)2-(SEBA-BDO)2, (ADA-BDO)2-(AZA-BDO)2, (ADA-BDO)2-(SEBA-BDO)2, (ADA-BDO)2-(BRA-BDO)2, where ADA corresponds to the ester of adipic acid with the diol component, AZA corresponds to the ester of azelaic acid with the diol component, SEBA corresponds to the ester of sebacic acid with the diol component, BRA corresponds to the ester of brassylic acid with the diol component, SUC corresponds to the ester of succinic acid with the diol component, PTA corresponds to the ester of terephthalic acid and BDO is the diol component 1,4-butanediol. By way of example cyclic oligomer (ADA-BDO-AZA-BDO) consists of one butylene adipate unit and one butylene azelate unit.

In addition to the dicarboxylic component and the diol component, the aliphatic-aromatic polyesters produced by the process according to the present invention preferably comprise repetitive units derived from at least one hydroxyacid or the corresponding lactone in amounts of between 0 and 49% and preferably between 0 and 30% in moles of the total moles of the dicarboxylic component.

Examples of suitable hydroxy acids are glycolic acid, hydroxybutyric acid, hydroxycaproic acid, hydroxyvaleric acid, 7-hydroxyheptanoic acid, 8-hydroxycaproic acid, 9-hydroxynonanoic acid, lactic acid or lactides.

The hydroxy acids may be inserted into the chain as they are, or may also be reacted with diacids or diols in advance.

In the process according to the present invention, the hydroxy acids are advantageously added during the esterification step.

Long molecules with two functional groups, including those with non-terminal functional groups, may also be present in quantities of no more than 10% in moles in relation to the total moles of the dicarboxylic component.

Examples are dimeric acids, ricinoleic acids and acids incorporating epoxy functional groups as well as polyoxyethylene having a molecular weight of between 200 and 10000.

In the process according to the present invention, these long molecules with two functional groups are advantageously added during the esterification step.

Diamines, amino acids and amino-alcohols may also be present in percentages of up to 30% in moles of the total moles of the dicarboxylic component.

In the process according to the present invention, such diamines, amino acids and amino alcohols are advantageously added during the esterification step.

During the esterification step of the process for the preparation of polyesters according to the present invention, one or more molecules characterised by having 3 or more reactive functional groups may be added in quantities of between 0.02 and 3% moles relative to the total moles of the dicarboxylic component (and any hydroxy acids) to obtain branched products.

Examples of these molecules are glycerol, pentaerythritol, trimethylolpropane, citric acid, dipentaerythritol, monoanhydrosorbitol, monoanhydromannitol, acid triglycerides or polyglycerols.

The molecular weight Mn of the polyesters obtained by the process according to the present invention is preferably greater than 20000, more preferably >30000, even more preferably >50000.

With regard to the polydispersity index of the molecular weights Mw/Mn, this is preferably between 1.5 and 10, more preferably between 1.6 and 5, and even more preferably between 1.8 and 2.5.

The molecular weights Mn and Mw can be measured by gel permeation chromatography (GPC). The determination can be conducted with the chromatographic system held at 40° C. using a set of two columns in series (particle diameters of 5 μm and 3 μm with mixed porosity), a refractive index detector, chloroform as eluent (flow rate 0.5 ml/min) and polystyrene as the reference standard.

In the process described in patent application WO2016/050963, through use of the catalyst comprising a mixture of at least one compound comprising Titanium and at least one compound comprising Zirconium, in which the Ti/(Ti+Zr) ratio by weight in the polycondensation step is equal to or above 0.01 and equal to or below 0.70, preferably equal to or above 0.02 and equal to or below 0.60, a smaller amount of residual cyclic oligomers may be obtained after extraction of the polycondensation distillates.

In particular, the content of these cyclic oligomers is measured gravimetrically after isolation from polycondensation distillates.

In the present invention, by instead using phosphorus-containing compounds in a mixture of at least one compound comprising titanium with a ratio of titanium to phosphorus of between 2 and 20, preferably between 3 and 15, it is possible to control the amount of mixed residual cyclic oligomers remaining within the formed polyester, where the ratio between cyclic oligomers containing at least two types of dicarboxylic aliphatic unit having an MM below 1000 and cyclic oligomers containing only one type of dicarboxylic aliphatic unit having an MM below 1000 is between 0.30 and 1.40.

The extracted residual mixed cyclic oligomers are determined gravimetrically.

An accurately weighed polymer sample of about 30 g was extracted with 150 ml of acetonitrile at 40° C. for 96 hours. The liquid phase was recovered by filtration and the granules on the filter were washed with 25 ml of acetonitrile. The two aliquots of liquid were combined in a 250 ml volumetric flask and the solvent was evaporated to constant weight at 45° C. in a rotary evaporator.

The composition of the residual mixed cyclic oligomers was analysed by dissolving the oligomers in 1 ml THF, diluting with acetonitrile to a concentration of approximately 1000 ppm. 100 μl acetonitrile/THF solution was diluted with 800 μl of methanol and 100 μl of aqueous 0.1% N ammonium acetate solution.

The analysis was performed by HPLC-MS using a Thermo Accela 1250 HPLC instrument interfaced to a Thermo LCQ Fleet mass spectrometer in ESI+ mode.

Species were separated using a Phenomenex Luna Omega C18 PS 100×2.1 mm 1.6 μm column eluting according to the profile described in Table 1.

TABLE 1
Elution profile

| | | % 0.1% N aqueous | |
|---|---|---|---|
| | | solution of ammonium | |
| Time | % Acetonitrile | acetate | μl/min |
| 0 | 30 | 70 | 300 |
| 2 | 30 | 70 | 300 |
| 50 | 95 | 5 | 300 |
| 60 | 95 | 5 | 300 |
| 65 | 30 | 70 | 300 |
| 70 | 30 | 70 | 300 |

The oligomers were recognised on the basis of the molecular mass (MM) of the protonated and ammonia adducts. The percentage of mixed residual cyclic oligomers was determined by processing the chromatogram in base peak mode and integrating the species recognised as cyclic oligomers on the basis of molecular mass. The ratio between the sum of the areas of the peaks assigned to oligomers containing at least 2 aliphatic acids having an MM below 1000 and the sum of the areas of the peaks assigned to cyclic oligomers containing only one type of aliphatic dicarboxylic unit having an MM below 1000 represents the fraction of mixed cyclic oligomers.

The terminal acid groups content of the aromatic aliphatic polyester is preferably below 100 meq/kg, preferably below 60 meq/kg, and even more preferably below 40 meq/kg.

The terminal acid groups content can be measured as follows: place 1.5-3 g of polyester in a 100 ml flask together with 60 ml of chloroform.

After the polyester has completely dissolved, add 25 ml of 2-propanol and, immediately before analysis, 1 ml of deionised water.

Titrate the resulting solution against a previously standardised solution of KOH in ethanol.

A suitable indicator, such as a glass electrode for acid-base titrations in non-aqueous solvents, is used to determine the end point of the titration.

The content of the terminal acid groups is calculated from the consumption of the KOH solution in ethanol according to the following equation:

$$Terminal acid groups content ( meq / kg polymer ) = \frac{⌊ ( {V}_{eq} - {V}_{b} ) \cdot T ⌋ \cdot 1000}{P}$$

where: Veq=ml of KOH solution in ethanol at the end point for sample titration; Vb=ml of KOH solution in ethanol required to achieve a pH of 9.5 during a blank titration; T=concentration of KOH solution in ethanol in mol/litre; P=weight of sample in grams.

When used for applications typical of plastics materials (such as bubble film formation, injection moulding, foam products, etc.), the Melt Mass-Flow Rate (MFR) for polyesters obtained by the process according to the present invention is preferably between 500 and 1 g/10 min, more preferably between 100 and 2 g/10 min, even more preferably between 80 and 3 g/10 min. Advantageously, an MFR between 25 and 3.5 g/10 min (measurement at 190° C./2.16 kg according to ISO 1133-1) may be used.

Preferably the aliphatic-aromatic polyesters obtained by the process according to the present invention have an intrinsic viscosity (measured using an Ubbelohde viscometer for solutions in CHCl3 at a concentration of 0.2 g/dl at 25° C.) of more than 0.4, preferably between 0.4 and 2, more preferably between 0.7 and 1.5 dl/g.

Preferably, polyesters obtained by the process according to the present invention are biodegradable.

In the meaning of the present invention, biodegradable polymers are understood to mean biodegradable polymers having a relative biodegradability of 90% or more after 180 days in comparison with microcrystalline cellulose according to ISO 14855-1 (2013).

Polyesters obtained by the process according to the present invention may be used in a blend with one or more polymers of synthetic or natural origin, whether or not biodegradable, which can also be obtained by reactive extrusion processes.

In particular, polyesters obtained by the process according to the present invention may be used in mixtures with biodegradable polyesters of the hydroxy-acid or polyester-ether type.

Of these biodegradable hydroxy acid polyesters, the preferred ones are: poly-L-lactic acid, poly-D-lactic acid and stereocomplex poly-DL-lactic acid, poly-caprolactone, polyhydroxybutyrate, polyhydroxybutyrate-valerate, polyhydroxybutyrate-propanoate, polyhydroxybutyrate-hexanoate, polyhydroxybutyrate-decanoate, polyhydroxybutyrate-dodecanoate, polyhydroxybutyrate-hexadecanoate, polyhydroxybutyrate-octadecanoate, poly-3-hydroxybutyrate-4-hydroxybutyrate.

Preferably, the mixtures of polyesters obtained by the process according to the present invention with the biodegradable hydroxy acid polyesters described above are characterised by a content of said biodegradable polyesters in the range from 1 to 99% by weight, preferably 5 to 95% by weight with respect to the sum of the weights of the polyesters obtained by the process according to the present invention.

Polyesters obtained by the process according to the present invention may also be used in mixtures with polymers of natural origin such as, for example, starch, cellulose, chitin, chitosan, alginates, proteins such as gluten, zein, casein, collagen, gelatin, natural gums, rosinic acid and its derivatives, lignins as such, or purified, hydrolysed, basified, etc. lignins, or their derivatives. Starches and cellulose may be modified, and these include starch or cellulose esters with a degree of substitution between 0.2 and 2.5, hydroxypropylated starches, starches modified with fat chains, and cellophane.

Mixtures of polyesters with starch are particularly preferred.

Starch may be used in both unstructured and gelatinised form or as a filler.

By destructured starch is meant the starch described in patents EP 0 118 240 and EP 0 327 505, in particular starch processed in such a way that it does not show the so-called ‘Maltese crosses’ under an optical microscope in polarised light and the so-called ‘ghosts’ under an optical microscope in phase contrast.

Starch may represent the continuous or dispersed phase, or it may be in co-continuous form.

The dimensions of the starch particles are measured in transverse cross-section with respect to the flow direction in extrusion, or in any case with respect to the direction in which the material is produced.

The particle size of the starch is measured from the two-dimensional shape resulting from the transverse cross-section. The average starch particle size is calculated as the arithmetic mean of the particle size.

If a particle has a circular cross-section, the particle size corresponds to the diameter of the circle.

In the case of particles having an elliptical cross-section or otherwise similar to an ellipse, the particle size (d) is calculated using the formula:

$$d = \sqrt{{d}_{1} \cdot {d}_{2}}$$

where d1 is the minor axis and d2 is the major axis of the ellipse to which the particle can be likened.

The starch particles are characterised by an arithmetic mean diameter of less than 1 micron and more preferably less than 0.5 μm measured as described above.

Preferably, the polyester mixtures obtained by the process according to the present invention together with the polymers of natural origin described above are characterised by a content of said polymers of natural origin in the range from 1 to 99% by weight, more preferably from 5 to 95% by weight, and more preferably from 10 to 40% by weight with respect to the sum of the weights of the polyesters obtained by the process according to the present invention.

Polyesters obtained by the process according to the present invention may also be used in mixtures with polyolefins, aromatic polyesters, polyesters and polyether-urethanes, polyurethanes, polyamides, polyamino acids, polyethers, polyureas, polycarbonates and mixtures thereof.

Among the polyolefins, those preferred are polyethylene, polypropylene, their copolymers, polyvinyl alcohol, polyvinyl acetate, polyethylene vinyl acetate and polyethylene vinyl alcohol.

Among aromatic polyesters, those preferred are: PET, PBT, PTT in particular having a renewable content >30% and furandicarboxylated polyalkylenes.

Among the latter, those preferred are: poly(1,2-ethylene-2,5-furandicarboxylate), poly(1,3-propylene-2,5-furandicarboxylate), poly(1,4-butylene-2,5-furandicarboxylate) and mixtures thereof.

Examples of polyamides are polyamide 6 and 6.6, polyamide 9 and 9.9, polyamide 10 and 10.10, polyamide 11 and 11.11, polyamide 12 and 12.12 and combinations thereof of the 6/9, 6/10, 6/11, 6/12 type.

The polycarbonates may be polyethylene carbonates, polypropylene carbonates, polybutylene carbonates, mixtures and copolymers thereof.

The polyethers may be polyethylene glycols, polypropylene glycols, polybutylene glycols, copolymers and mixtures thereof having molecular weights from 70,000 to 500,000.

Preferably, the polyester blends obtained by the process according to the present invention using the polymers described above (polyolefins, aromatic polyesters, polyesters and polyether urethanes, polyurethanes, polyamides, polyamino acids, polyethers, polyureas, polycarbonates and mixtures thereof) are characterised by a content of said polymers varying in the range from 0.5 to 99% by weight, more preferably between 5 and 50%> by weight with respect to the sum of the weights of the polyesters obtained by the process according to the present invention.

The polyesters obtained by the process according to the present invention are extremely suitable for use alone or in blends with other polymers in many practical applications for the manufacture of products such as films, fibres, non-wovens, foils, and moulded, thermoformed, blown, expanded and laminated articles, including those made using the extrusion coating technique.

Examples of products comprising polyesters obtained by the process according to the present invention are:
films, with mono and biaxially oriented films, and multilayer films with other polymer materials;
film for use in the agricultural sector as mulching film;
stretch film, including thin film for food, baling in agriculture and waste packaging;
bags and liners for the collection of organic material such as food waste and grass cuttings;
thermoformed food packaging, both single-layer and multi-layer, such as containers for milk, yoghurt, meat, drinks, etc.
coatings obtained using the extrusion coating technique;
multilayer laminates with layers of cardboard, plastics, aluminium, metallised films;
expanded or expandable beads for the production in special formats for sintering;
expanded and semi-expanded products including expanded blocks formed from pre-expanded particles;
expanded foams, thermoformed expanded sheets and containers for food packaging made therefrom;
containers for fruit and vegetables in general;
compositions with gelatinised, de-structured and/or complex starch, natural starch, flours, other fillers of natural, vegetable or inorganic origin as fillers;
fibres, microfibres, composite fibres with a core consisting of rigid polymers such as PLA, PET, PTT, etc., and an outer shell of the material according to the invention, dablens composite fibres, fibres having various cross-sections from round to lobed multi-fibre, flocked, woven and non-woven or spunbonded or thermobonded fabrics for the health, hygiene, agricultural and clothing sectors.

They may also be used in applications as a substitute for plasticised PVC.

In a particularly preferred aspect, the polyesters according to the present invention are used to make films.

Processing of the aliphatic-aromatic polyester granules according to the invention by means of bubble film technology surprisingly makes it possible to optimise the process flow rate due to the high stability of the process itself (stability of the tubular width, homogeneity of thicknesses along the perimeter of the bubble, no film adhesion phenomena in the rollers).

The process according to the present invention comprises an esterification or transesterification stage and a polycondensation stage, and is characterised in that said polycondensation stage is carried out in the presence of a catalyst comprising at least one compound comprising Titanium and possibly at least one compound comprising Zirconium. Where a Zirconium compound is present, the Ti/(Ti+Zr) ratio by weight is equal to or above 0.01 and equal to or below 0.7, preferably equal to or above 0.02 and equal to or below 0.60.

In addition, the catalyst is used in mixtures with phosphorus compounds belonging to the family of organic phosphates or phosphites.

Advantageously, the compound containing phosphorus is selected from compounds of general formula (1) or (2)

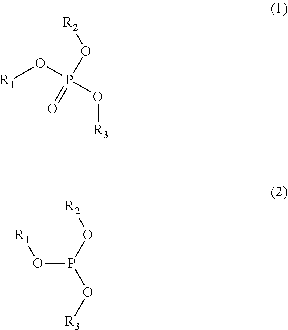

where R1, R2 and R3 may be selected from any of H, C1-C20 alkyl or cycloalkyl, C6-C20 aryl, alkyl aryl, or a polyalkylene oxide or polyalkylalkylene oxide chain.

In a particularly preferred aspect, the phosphorus-containing compound is trioctyl phosphate. In a preferred embodiment of the process according to the invention, the catalyst comprises a mixture of at least one compound comprising titanium and the ratio of titanium to phosphorus by weight is between 2 and 20, preferably between 3 and 15.

The esterification/transesterification stage is preferably fed with a molar ratio between aliphatic diols and dicarboxylic acids, their esters and salts, of preferably between 1 and 2.5, preferably between 1.05 and 1.9.

The dicarboxylic acids, their esters or salts, aliphatic diols and any other co-monomers constituting the polyester may be fed to this stage separately, thus mixing in the reactor, or alternatively may be pre-mixed, preferably at T<70° C., before being sent to the reactor.

It is also possible to pre-mix some of the components and subsequently change their composition, for example during the esterification/transesterification reaction.

In the case of polyesters in which the dicarboxylic component comprises repeating units derived from several dicarboxylic acids, whether aliphatic or aromatic, it is also possible to pre-mix some of these with aliphatic diols, preferably at T<70° C., adding the remaining portion of the dicarboxylic acids, diols and any other co-monomers to the esterification/transesterification reactor.

The esterification/transesterification step of the process according to the present invention is advantageously conducted at a temperature of 200-250° C. and a pressure of 0.7-1.5 bar, preferably in the presence of an esterification/transesterification catalyst.

The esterification/transesterification catalyst, which may also advantageously be used as a component of the catalyst for the polycondensation stage, may in turn be fed directly to the esterification/transesterification reactor or may also first be dissolved in an aliquot of one or more of the dicarboxylic acids, their esters or salts, and/or aliphatic diols, in order to promote dispersion in the reaction mixture and make it more uniform.

In a preferred embodiment, the esterification/transesterification catalyst is selected from organometallic tin compounds, for example stannoic acid derivatives, titanium compounds, for example, titanates such as tetrabutyl ortho-titanate or tetra(isopropyl) ortho-titanate, zirconium compounds, for example zirconates such as tetrabutyl ortho-titanate or tetra(isopropyl) ortho-titanate, Antimony compounds, Aluminium, for example Al-triisopropyl, and Zinc compounds and mixtures thereof.

With regard to the organometallic esterification/transesterification catalysts of the above-mentioned type, during the esterification/transesterification step of the process according to the present invention they are present in concentrations of preferably between 12 and 120 ppm of metal relative to the amount of polyester that can theoretically be obtained by converting all the dicarboxylic acid fed to the reactor.

In a preferred embodiment, the catalyst for the esterification/transesterification step is a titanate, more preferably diisopropyl, triethanolamino titanate, preferably used in a concentration from 12 to 120 ppm of metal to a quantity of polyester that can theoretically be obtained by converting all of the reactor-fed dicarboxylic acid.

Preferably, the reaction time for the esterification/transesterification step in the process according to the present invention is between 4 and 8 hours.

At the end of the esterification/transesterification step an oligomer product having Mn<5000, an intrinsic viscosity of 0.05-0.15 dl/g, and an acidity <150 meq/kg is obtained.

In a preferred embodiment of the process according to the present invention, the catalyst is fed to the polycondensation stage together with the oligomer product at the end of the esterification/transesterification stage.

The polycondensation step in the process according to the present invention is carried out in the presence of a catalyst comprising titanium, possibly with zirconium or mixtures thereof, and a phosphorus-containing compound belonging to the family of organic phosphates or phosphites, with a total amount of titanium of 80-500 ppm, compared to the amount of polyester that could theoretically be obtained by converting all the dicarboxylic acid fed to the reactor into the catalyst. The ratio of Titanium to phosphorus should be between 2 and 20, preferably between 3 and 15. If present, the total amount of Zirconium should be such that the Ti/(Ti+Zr) ratio is maintained in the range 0.01-0.70.

In a preferred embodiment, the polycondensation catalyst comprising Titanium is a titanate advantageously selected from compounds having general formula Ti(OR)4 in which R is a ligand comprising one or more atoms of Carbon, Oxygen, Phosphorus and/or Hydrogen.

Several ligand groups R may be present on the same Titanium atom, but preferably these groups will be the same in order to facilitate titanate preparation.

Furthermore, two or more R ligands may be derived from a single compound and may be chemically bonded together in addition to being bound by Titanium (so-called multidentate ligands such as triethanolamine, citric acid, glycolic acid, malic acid, succinic acid, ethane diamine).

R is advantageously selected from H, triethanolamine, citric acid, glycolic acid, malic acid, succinic acid, 3-oxobutanoic acid, ethane diamine and the linear or branched C1-C12 alkyl residues such as ethyl, propyl, n-butyl, pentyl, isopropyl, isobutyl, isopentyl, hexyl, ethylhexyl. In a preferred embodiment, R is selected from C1-C12 alkyl residues, preferably C1-C8, more preferably n-butyl.

The preparation of titanates is known in the literature. Typically, these are prepared by reacting titanium tetrachloride and a precursor alcohol of formula ROH in the presence of a base such as ammonia, or by transesterification from other titanates.

Commercial examples of titanates that may be used in the process according to the present invention include Tyzor® TPT (tetra isopropyl titanate), Tyzor® TnBT (tetra n-butyl titanate) and Tyzor® TE (diisopropyl triethanolamino titanate).

If the polycondensation catalyst comprising Zirconium is used in conjunction with that comprising Titanium, this will be a zirconate advantageously selected from compounds having the general formula Zr(OR)4 in which R is a ligand group comprising one or more atoms of Carbon, Oxygen, Phosphorus and/or Hydrogen.

As in the case of titanates, several different but preferably identical ligand groups R may be present on the same Zirconium atom in order to favour preparation of the zirconate.

In addition to this, two or more R ligands may be derived from a single compound or may be chemically bound together in addition to being bound to Zirconium (so-called multidentate ligands such as triethanolamine, citric acid, glycolic acid, malic acid, succinic acid, ethane diamine). R is advantageously selected from H, triethanolamine, citric acid, glycolic acid, malic acid, succinic acid, 3-oxobutanoic acid, ethane diamine and linear or branched C1-C12 alkyl residues such as ethyl, propyl, n-butyl, pentyl, isopropyl, isobutyl, isopentyl, hexyl or ethylhexyl. In a preferred embodiment, R is selected from C1-C12 alkyl residues, preferably C1-C8, more preferably n-butyl.

The preparation of zirconates is known in the literature, and is similar to that described above for titanates.

Commercial examples of zirconates that may be used in the process according to the present invention include Tyzor® NBZ (tetra n-butyl zirconate), Tyzor NPZ (tetra n-propyl zirconate), IG-NBZ (tetra n-butyl zirconate), Tytan TNBZ (tetra n-butyl zirconate), Tytan TNPZ (tetra n-propyl zirconate).

The polycondensation catalyst and phosphorus-containing compounds are fed to the polycondensation stage by feeding the various components to the reactor separately.

It is also possible to pre-mix some of the components and subsequently adjust the composition of the catalyst, for example when it is placed in contact with the oligomer product.

When a catalyst containing Titanium and/or Zirconium compounds is used in the esterification/transesterification step of the process according to the present invention, in a preferred embodiment of the process according to the present invention this catalyst is not separated from the oligomer product and is fed together with it to the polycondensation stage and advantageously used as a polycondensation catalyst or as a component thereof, with possible adjustment of the molar ratio between Titanium and Zirconium by the addition of suitable quantities of Titanium and Zirconium compounds to said polycondensation stage.

It is possible that the catalyst for the polycondensation stage may be the same as that for the esterification/transesterification stage.

The polycondensation stage is advantageously carried out by feeding the oligomer product to the polycondensation reactor and reacting it in the presence of the catalyst at a temperature of 220-260° C. and a pressure between 0.5 mbar and 350 mbar.

Preferably, the reaction time for the polycondensation step in the process according to the present invention is between 4 and 8 hours.

Depending on the specific molecular weight properties and the desired viscosity of the polyester, the process according to the present invention may provide for one or more stages of chain extension, reactive processing or reactive extrusion, including with other polymers through the use of peroxides, divinyl ethers, bisoxazolines, polyepoxides, di- and polyisocyanates, carbodiimides or dianhydrides after the polycondensation stage.

The invention will now be illustrated by some embodiments which are intended to be illustrative and not limiting the scope of protection of this patent application.

### EXAMPLES

Example 1 (comparative)—Preparation of poly(1,4-butylene adipate-co-1,4-butylene azelaic acid-co-1,4-butylene terephthalate) [PBATAz] with a molar ratio of azelaic acid to the sum of aliphatic carboxylic acids of 0.15, without the addition of a phosphorus-containing compound

### Esterification Stage

In a molar ratio of diol to dicarboxylic acid (MGR) of 1.50, 8068 g of terephthalic acid, 6802 g of adipic acid, 1546 g of azelaic acid, 13961 g of 1,4-butanediol, 4.76 g of glycerol and 5.50 g of an 80% w/w ethanolic solution of diisopropyl triethanolamino titanate (Tyzor TE, corresponding to 21 ppm of metal with respect to the amount of PBATAz theoretically obtainable by converting all the adipic acid, all the azelaic acid and all the terephthalic acid fed to the reactor) were loaded into a steel reactor having a geometric capacity of 60 litres, equipped with a mechanical stirring system, an inlet for nitrogen, a distillation column, a knock-down system for high-boiling distillates and a connection to a high-vacuum system.

The temperature of the mass was gradually raised to 230° C. over a period of 120 minutes.

### Polycondensation Stage

When 95% of the theoretical water had been distilled off, 20.20 g of tetra n-butyl titanate (corresponding to 129 ppm of metal relative to the amount of PBATAz theoretically obtainable by converting all the adipic acid, all the azelaic acid and all the terephthalic acid fed to the reactor) was added. The reactor temperature was then raised to 242° C. and the pressure was gradually reduced to below 1.2 mbar over 60 minutes. The reaction was allowed to proceed for about 4.30 hours, the time required to obtain a PBATAz with an MFR of 4.3 g/10 minutes (at 190° C. and 2.16 kg), and the material was then discharged into a water bath in the form of a string and granulated.

Example 2—Preparation of poly(1,4-butylene adipate-co-1,4-butylene azelaic acid-co-1,4-butylene terephthalate) [PBATAz] with a molar ratio of 0.15 between azelaic acid and the sum of the aliphatic carboxylic acids, with the addition of a phosphorus-containing compound with a Ti/P ratio of 10 by weight.

Example 1 was repeated with the addition of 4.63 g of trioctyl phosphate to the polycondensation step (corresponding to 15 ppm phosphorus with respect to the amount of PBATAz theoretically obtainable by converting all the adipic acid, all the azelaic acid and all the terephthalic acid fed to the reactor, thus corresponding to a Ti/P ratio of 10 by weight).

Example 3—Preparation of poly(1,4-butylene adipate-co-1,4-butylene azelaic acid-co-1,4-butylene terephthalate) [PBATAz] with a molar ratio of 0.4 between azelaic acid and the sum of the aliphatic carboxylic acids, with the addition of a phosphorus-containing compound with a Ti/P ratio of 10 by weight.

Example 2 was repeated by feeding the monomers at the Esterification Step with molar ratio of azelaic acid to total aliphatic dicarboxylic acids of 0.4 instead of 0.15. 7863 g of terephthalic acid, 4679 g of adipic acid, 4017 g of azelaic acid, 13605 g of 1,4-butanediol, 4.64 g of glycerol and 5.50 g of an 80% w/w ethanolic solution of diisopropyl triethanolamino titanate (Tyzor TE, corresponding to 21 ppm of metal with respect to the amount of PBATAz theoretically obtainable by converting all the adipic acid, all the azelaic acid and all the terephthalic acid fed to the reactor) were added.

Example 4 (comparative)—Preparation of poly(1,4-butylene adipate-co-1,4-butylene azelaic acid-co-1,4-butylene terephthalate) [PBATAz] with a molar ratio of azelaic acid to the sum of aliphatic carboxylic acids of 0.4, with the addition of a phosphorus-containing compound with a Ti/P ratio of 10 by weight.

Example 3 was repeated, carrying out the Polycondensation Phase under temperature and pressure conditions outside the range of the invention. Instead of raising the reactor temperature to 242° C. and gradually reducing the pressure to less than 1.2 mbar over 60 minutes, the reactor temperature was then raised to 267° C. and the pressure was gradually reduced to a value of less than 3 mbar over 60 minutes.

Samples of the polyesters according to Examples 1-4 were taken at the start of the reactor unloading stage (IS) and at the end of the reactor unloading stage (FS) to determine their MFR, terminal acid groups content (CEG), mixed residual cyclic oligomers content and the ratio between the cyclic oligomers containing at least two types of dicarboxylic aliphatic units having an MM below 1000 and the cyclic oligomers containing only one type of dicarboxylic aliphatic unit having an MM below 1000, according to the methods described in this application. The values shown in Table 1 are the averages of the measured values.

| | Azelaic | | | | | | | | | | |
|---|---|---|---|---|---|---|---|---|---|---|---|
| | acid | | | | | | | | | | |
| | (azelaic | | | | | | | | | | |
| | acid + | | | | | | | | | | Ratio |
| | adipic | | | | | | | | | | between |
| | acid) | Phosphorus- | Ti | | | | | MFR | | | mixed |
| | molar | containing | (ppm | P | Ti/P | T | Pressure | (g/10³) | CEG | Oligomers | cyclic |
| Example | ratio | additive (P) | wt) | (ppm/wt) | (wt/wt) | (° C.) | (mbar) | 190° C./2.16 kg | meq/kg | % | oligomers |
| 1 | 0.15 | no | 150 | 0 | — | 242 | 1.2 | 4.3 | 38 | 4.7 | 0.44 |
| comparative | | | | | | | | | | | |
| 2 | 0.15 | Trioctyl | 150 | 15 | 10 | 242 | 1.2 | 4.1 | 37 | 2.2 | 0.48 |
| | | phosphate | | | | | | | | | |
| 3 | 0.40 | Trioctyl | 150 | 15 | 10 | 242 | 1.2 | 4.3 | 41 | 2.0 | 0.78 |
| | | phosphate | | | | | | | | | |
| 4 | 0.40 | Trioctyl | 150 | 15 | 10 | 267 | 3 | 4.3 | 38 | 4.8 | 0.81 |
| comparative | | phosphate | | | | | | | | | |

The granules in Example 1 (comparative) and Example 2 were fed to a Ghioldi model blown film machine with a 40 mm screw diameter and L/D 30. The film-forming head was characterised by an air gap of 0.9 mm and L/D 12. With the aim of obtaining films with a thickness of 20 microns (10+10), the film-forming temperature was set at 145° C. and the blowing ratio (BUR) at 3.2. The blowing ratio (BUR) is defined as the ratio of the bubble diameter to the die diameter.

During the processing of the granules in Example 1 (comparative), the maximum flow rate that allowed the 20 micron film thickness to be obtained by means of a stable process (stability of the tube width, homogeneity of the thickness along the perimeter of the bubble, absence of film adhesion phenomena in the rollers) was 15 m/min; whereas in processing of the granules in Example 2 it was possible to operate at 19 m/min.

1. An aliphatic-aromatic polyester comprising:
a. a dicarboxylic component comprising:
a1) 40-80% mol of units deriving from at least one aromatic dicarboxylic acid,
a2) 20-60% mol of units deriving from at least two saturated dicarboxylic acids C4-C24, their alkyl esters C1-C24, their salts and mixtures thereof.
b. a diol aliphatic component;
characterized by a content of residual cyclic mixed oligomers measured by a gravimetric method as described in the description between 1.0% and 4.0% and, in which said residual cyclic mixed oligomers are characterized by a ratio between cyclic oligomers containing at least two types of dicarboxylic aliphatic unit having MM lower than 1000 and cyclic oligomers containing only one type of dicarboxylic aliphatic unit lower than 1000 between 0.30 and 1.40, wherein the ratio is determined by the method described in the description that involves an HPLC-MS analysis; and further characterized in that at least a saturated aliphatic dicarboxylic acid of component a2 is between 45% mol and 95% mol with respect to the sum of all the other saturated aliphatic dicarboxylic acids.

2. An aliphatic-aromatic polyester according to claim 1 in which said diol aliphatic component is selected from the group constituted by 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecandiol, 1,4-cyclohexanedimethanol, neopentylglycol, 2-methyl-1,3-propanediol, dianhydrosorbitol, dianhydromannitol, dianhydroiditol, cyclohexanediol, cyclohexanemethanediol, pentaerythritol, glycerol, polyglycerol, trimethylolpropane, and polyalkylene glycols with molecular weight of 100-4000, and mixtures thereof.

3. An aliphatic-aromatic polyester according to claim 2, in which said diol aliphatic component is selected from 1,2-ethandiol and 1,4-butanediol.

4. An aliphatic-aromatic polyester according to claim 1, in which said aromatic dicarboxylic acid is selected from terephthalic acid, isophthalic acid, 2,5-furandicarboxylic acid, their esters, their salts and mixtures thereof.

5. An aliphatic-aromatic polyester according to claim 4, in which said aromatic dicarboxylic acid is terephthalic acid.

6. An aliphatic-aromatic polyester according to claim 1 in which the aliphatic dicarboxylic acids are selected from the group constituted by succinic acid, 2-ethyl succinic acid, glutaric acid, 2-methylglutaric acid, adipic acid, pimelic acid, suberic acid, azelaic acid, sebacic acid, undecanoic acid, dodecanoic acid, and brassylic acid, their alkylic esters C1-C24.

7. An aliphatic-aromatic polyester according to claim 6 in which one of the aliphatic dicarboxylic acids is azelaic acid.

8. A process for the production of aliphatic-aromatic polyesters in which according to claim 1 comprising the steps of:
1. submitting to an esterification and/or a transesterification step a mixture containing an aliphatic diol and at least a dicarboxylic acid, an ester, its salt or its derivative thereof for producing an oligomer;
2. submitting to a policondensation said oligomer obtained from step 1 at a temperature comprised between 220° C. and 260° C. and at a pressure comprised from 0.5 mbar and 350 mbar presence of a catalyst comprising titanium, optionally with zirconium or their mixtures thereof, and a phosphorus containing compound belonging to the family of organic phosphates or phosphites.

9. A process according to claim 8 in which the phosphorus containing compound is selected from 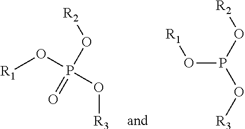
in which R1, R2 and R3 may indifferently be selected from H, C1-C20 alkyl or C1-C-20 cycloalkyl, aryl or C6-C-20 alkyl aryl, or a polyalkylene oxide or an alkyl-polyalkylene oxide chain.

10. The process according to claim 8 in which the catalyst comprises a mixture of at least a compound containing titanium.

11. The process according to claim 8 in which the molar ratio between titanium and phosphorus is between 2 and 20.

12. An aliphatic-aromatic polyester according to claim 2, in which said aromatic dicarboxylic acid is selected from terephthalic acid, isophthalic acid, 2,5-furandicarboxylic acid, their esters, their salts and mixtures thereof.

13. An aliphatic-aromatic polyester according to claim 3, in which said aromatic dicarboxylic acid is selected from terephthalic acid, isophthalic acid, 2,5-furandicarboxylic acid, their esters, their salts and mixtures thereof.

14. An aliphatic-aromatic polyester according to claim 2 in which the aliphatic dicarboxylic acids are selected from the group constituted by succinic acid, 2-ethyl succinic acid, glutaric acid, 2-methylglutaric acid, adipic acid, pimelic acid, suberic acid, azelaic acid, sebacic acid, undecanoic acid, dodecanoic acid, and brassylic acid, their alkylic esters C1-C24.

15. An aliphatic-aromatic polyester according to claim 3 in which the aliphatic dicarboxylic acids are selected from the group constituted by succinic acid, 2-ethyl succinic acid, glutaric acid, 2-methylglutaric acid, adipic acid, pimelic acid, suberic acid, azelaic acid, sebacic acid, undecanoic acid, dodecanoic acid, and brassylic acid, their alkylic esters C1-C24.

16. An aliphatic-aromatic polyester according to claim 4 in which the aliphatic dicarboxylic acids are selected from the group constituted by succinic acid, 2-ethyl succinic acid, glutaric acid, 2-methylglutaric acid, adipic acid, pimelic acid, suberic acid, azelaic acid, sebacic acid, undecanoic acid, dodecanoic acid, and brassylic acid, their alkylic esters C1-C24.

17. An aliphatic-aromatic polyester according to claim 5 in which the aliphatic dicarboxylic acids are selected from the group constituted by succinic acid, 2-ethyl succinic acid, glutaric acid, 2-methylglutaric acid, adipic acid, pimelic acid, suberic acid, azelaic acid, sebacic acid, undecanoic acid, dodecanoic acid, and brassylic acid, their alkylic esters C1-C24.

18. The process according to claim 9 in which the catalyst comprises a mixture of at least a compound containing titanium.

19. The process according to claim 9 in which the molar ratio between titanium and phosphorus is comprised between 2 and 20.

20. The process according to claim 10 in which the molar ratio between titanium and phosphorus is comprised between 2 and 20.
